(19) United States
(12) Patent Application Publication
(10) Pub. No.: US 2013/0286200 A1
(43) Pub. Date: Oct. 31, 2013

(54) TELEVISION RECEIVER AND ELECTRONIC DEVICE

(71) Applicant: KABUSHIKI KAISHA TOSHIBA, Tokyo (JP)

(72) Inventors: Hirokazu KAWASAKI, Fussa-shi (JP); Minoru ENOMOTO, Higashiyamato-shi (JP)

(73) Assignee: KABUSHIKI KAISHA TOSHIBA, Tokyo (JP)

(21) Appl. No.: 13/734,200

(22) Filed: Jan. 4, 2013

(30) Foreign Application Priority Data
Apr. 25, 2012 (JP) 2012-099693

(51) Int. Cl. H04N 7/18

(52) U.S. Cl. CPC H04N 7/18
USPC 348/143

(57) ABSTRACT

According to one embodiment, a television receiver is provided with a support section. The support section supports the display panel such that the display panel inclines, with the perpendicular line of the display screen of the display panel oriented upward. A camera is fixed to the display panel above the display screen, oriented downward with respect to the perpendicular line of the display screen.

### CROSS-REFERENCE TO RELATED APPLICATIONS

This application is based upon and claims the benefit of priority from Japanese Patent Application No. 2012-099693, filed Apr. 25, 2012, the entire contents of which are incorporated herein by reference.

### FIELD

Embodiments described herein relate generally to a television receiver and an electronic device having a display screen and a camera.

### BACKGROUND

A notebook personal computer (note PC) provided with a camera capable of photographing a user of the computer, for example, is known as an electronic device with a camera located near its display screen. For instance, the camera can rotate front to back through 180°.

Since the display panel of the note PC is swingable through a relatively large angle with respect to the PC proper, it is convenient to the user to set the camera adjustable in angle.

In contrast, to set the camera rotatable, it is necessary to provide, at an edge portion of the display panel, a mechanism for rotating the camera, which inevitably makes the structure complex and increases the manufacturing cost.

In light of the above, there is a need for development of a television receiver and an electronic device with a camera, which are of high convenience and can be produced at low cost.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view illustrating an appearance of a personal computer as an example of a television receiver and an electronic device according to an embodiment;

FIG. 2 is a side view taken when the PC of FIG. 1 is seen in the direction indicated by arrow F2 in FIG. 1;

FIG. 3 is a partially enlarged sectional view taken along line F3-F3 in FIG. 1;

FIG. 4 is a schematic view illustrating the positional relationship between the PC of FIG. 1 and the user assumed when the PC is placed with a relatively small inclination angle;

FIG. 5 is a schematic view illustrating the positional relationship between the PC of FIG. 1 and the user assumed when the PC is placed with a relatively large inclination angle;

FIG. 6 is a partially enlarged perspective view illustrating the camera attachment portion of the backside of a mask incorporated in the PC shown in FIG. 1;

FIG. 7 is a partially enlarged perspective view illustrating a state in which a camera module is attached to the backside of the mask shown in FIG. 6;

FIG. 8 is a perspective view taken when the camera module of FIG. 7 is seen from the front side of the mask;

FIG. 9 is an exploded view of the camera module of FIG. 8;

FIG. 10 is a schematic view illustrating a state in which a static electricity sheet incorporated in the camera module of FIG. 8 is partially developed; and

FIG. 11 is a perspective view illustrating a module plate and a steel plate incorporated in the camera module of FIG. 8 and viewed from behind.

### DETAILED DESCRIPTION

Various embodiments will be described hereinafter with reference to the accompanying drawings.

In general, according to one embodiment, a television receiver has a display panel with a display screen, and a support section supporting the display panel. The support section supports the display panel such that the display screen inclines with a perpendicular line P thereof oriented upward. A camera 6 is fixed to the display panel above the display screen, oriented downward with respect to the perpendicular line P of the display screen.

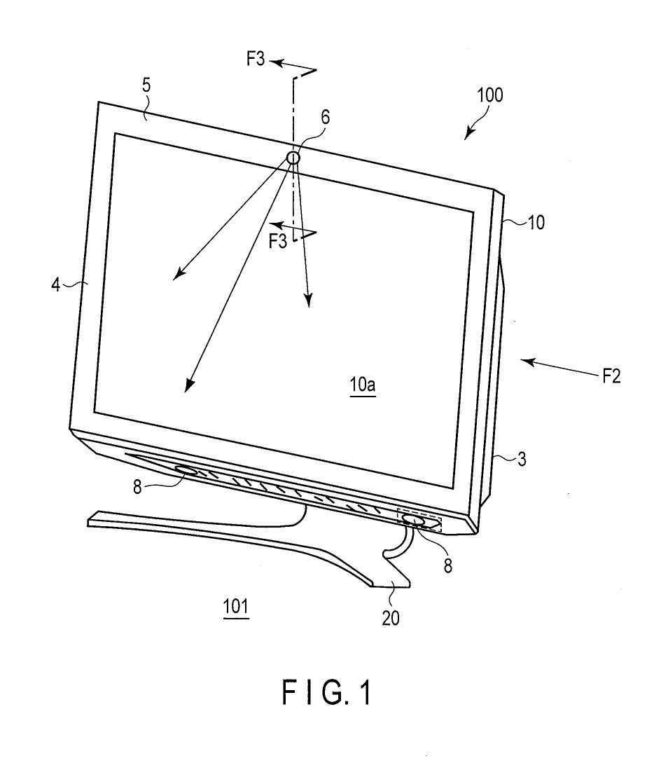

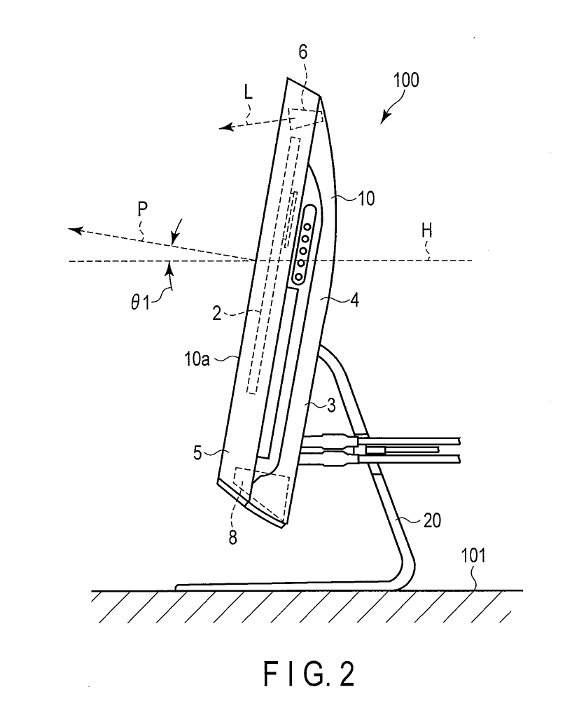

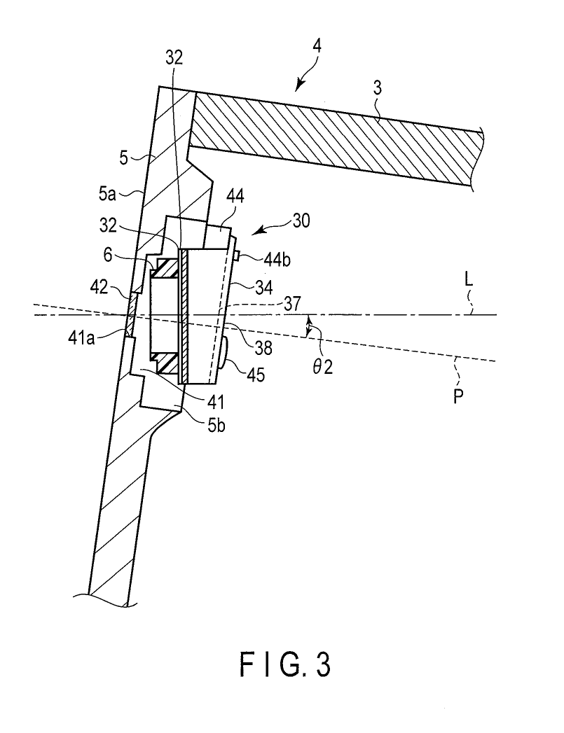

FIG. 1 is a perspective view, illustrating an appearance of a personal computer 100 (hereinafter, the PC 100) with a function of receiving broadcast waves, as an example of a television receiver and an electronic device according to the embodiment. FIG. 2 is a side view taken when the PC 100 is seen in the direction indicated by arrow F2 in FIG. 1. FIG. 3 is a partially enlarged sectional view taken along line F3-F3 in FIG. 1.

The PC 100 comprises a display panel 10 (PC proper or main unit) having a display screen 10a as a front surface, and a stand 20 (support section) supporting the backside of the display panel 10. The stand 20 of the embodiment has a structure for supporting the display panel 10 such that the panel 10 is situated above the upper surface 101 (hereinafter referred to as the “installation surface 101) of, for example, a table, as is shown in FIG. 1. However, the stand 20 is not limited to this structure, but may have such a structure (not shown) as a photo frame, which supports the backside of the display panel 10 with the lower end thereof kept in contact with the installation surface 101.

In any case, the stand 20 supports the display panel 10 in an inclined state, in which line P perpendicular to the display screen 10a is directed upward with respect to the horizontal line H. As a result, the display screen 10a becomes easily viewable to the user. The stand 20 of the embodiment has a support mechanism capable of adjusting the inclination angle θ1 of the display panel 10 so that the perpendicular line P of the display screen 10a will incline within an angular range of 15° to 30° with respect to the horizontal line H. Namely, the inclination angle θ1 of the display panel 10 is set adjustable within an angular range of 15° to 30° with respect to the horizontal line H.

The display panel 10 has a housing 4 that contains a display unit 2. The housing 4 contains a chassis (not shown) to which the display unit 2 is attached. Further, the stand 20 is also attached to the chassis via the above-mentioned support mechanism. Electronic components (not shown), such as a circuit board, are further attached to the chassis.

A camera 6 is provided in the housing 4 above the display unit 2. The housing 4 comprises a backside cover 3 covering the backside of the display panel 10, and a rectangular frame-shaped mask 5 covering the periphery of the display screen 10a on the front side of the display panel 10. The mask 5 has a front surface 5a that forms substantially a flat surface along with the display screen 10a. The camera 6 is secured to the backside of the mask 5 at an attachment angle θ2, described later, with respect to the display screen 10a (i.e., the front surface 5a of the mask 5).

Namely, the camera 6 of the embodiment does not have a rotation mechanism for angle adjustment for changing the orientation of the camera, and is fixed to the display panel 10, unlike the prior art PC mentioned above. A pair of loud speakers 8 are provided near the lower end of the housing 4.

As shown in FIGS. 2 and 3, the camera 6 is fixed to the backside of the mask 5 such that an optical axis L thereof is inclined downward with respect to the perpendicular line P of the display screen 10a. The angle between the optical axis L and the perpendicular line P will be hereinafter referred to as the “attachment angle θ2” of the camera 6. Thus, the attachment angle θ2 of the camera 6 is set such that when the display panel 10 is inclined to orient the display screen 10a upward, the camera 6 secured to the mask 5 is oriented toward a user who faces the display screen 10a.

In the embodiment, since the camera 6 is fixed to the display panel 10, the user cannot change the orientation of the camera 6. However, if the attachment angle θ2 of the camera 6 is beforehand appropriately set so that there is no need of adjusting the orientation of the camera 6, this enhances the convenience of the user. Further, in the embodiment, since the camera 6 is fixed, there is no need of a rotation mechanism for attaching the camera 6 in a rotatable manner, which enables the structure to be made simple and hence reduces the manufacturing cost.

In an electronic device, such as the PC 100 of the embodiment, which is placed on the installation surface 101 by means of the stand 20, the display panel thereof is not so greatly rotated (inclined) unlike the note PC aforementioned as the prior art. Accordingly, changes in the inclination angle θ1 of the display panel 10 are smaller than in the case of the note PC. Actually, in the PC 100 of the embodiment, the inclination angle θ1 of the display panel 10 can be adjusted only within a range of 15° to 30°. Therefore, in the PC 100 of the embodiment, although the camera 6 is fixed on the display panel 10, the possibility of user's face falling outside the view angle of the camera 6 is rather low within the above-mentioned narrow range of the inclination angle θ1. By appropriately setting the attachment angle θ2 of the camera 6, the user's face can be securely made to fall within the view angle of the camera 6.

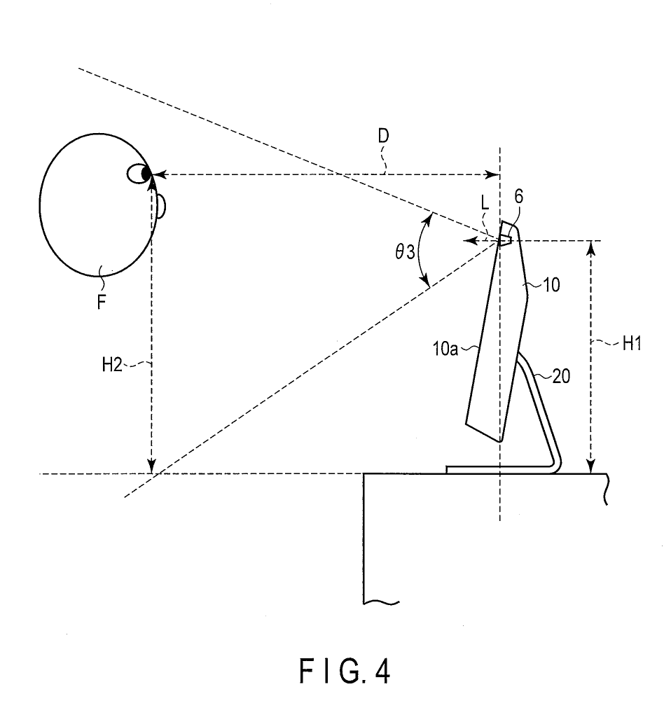

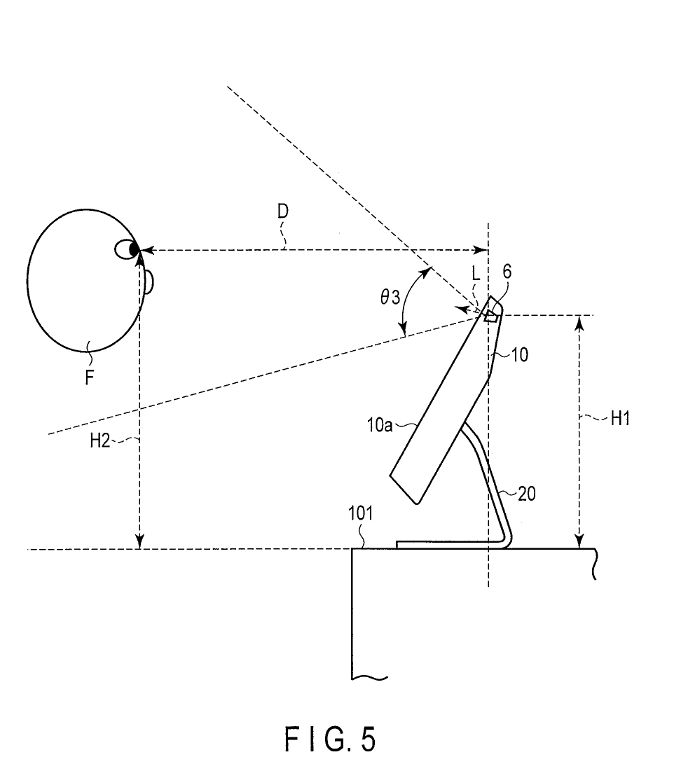

Referring now to FIGS. 4 and 5, a description will be given of an appropriate attachment angle θ2 (see FIG. 3) for the camera 6. FIG. 4 is a schematic view illustrating the positional relationship between the user and the display panel 10 of the PC 100, assumed when the inclination angle θ1 of the display panel 10 is set to a lowest value of 15°. Similarly, FIG. 5 is a schematic view illustrating the positional relationship between the user and the display panel 10 of the PC 100, assumed when the inclination angle θ1 of the display panel 10 is set to a highest value of 30°. Thus, the display panel 10 can be inclined through the inclination angle θ1 between the positions shown in FIGS. 4 and 5. There is no case where the inclination angle θ1 is smaller than in the case of FIG. 4, or is greater than in the case of FIG. 5.

Where the camera 6 is fixed to the display panel 10 as in the embodiment, the angle of the camera 6 (i.e., the angle of the optical axis L of the camera) with respect to the vertical plane is uniquely determined in accordance with the inclination angle θ1 of the display panel 10. In other words, if the orientation (angle) of the camera 6 is intended to be changed, the inclination angle θ1 of the display panel 10 is changed. From another viewpoint, it is sufficient if the user's face F facing the display screen 10a falls within the view angle θ3 of the camera 6 with respect to the vertical plane, irrespective of the angle (orientation) of the camera 6 (i.e., the inclination angle θ1 of the display panel 10) set within the angular movable range.

For instance, when the inclination angle θ1 of the display panel 10 is set smallest (15° in the embodiment) as shown in FIG. 4, the view angle θ3 of the camera 6 is lowest with respect to the vertical plane, and the upper end of the user's face F is closest to the upper end of the view angle θ3. At this time, if the upper end of the user's face F is within the view angle θ3, the attachment angle θ2 of the camera 6 can be determined to be an allowable value. In contrast, when the inclination angle θ1 of the display panel 10 is set largest (30° in the embodiment) as shown in FIG. 5, the view angle θ3 of the camera 6 is highest with respect to the vertical plane, and the lower end of the user's face F is closest to the lower end of the view angle θ3. At this time, if the lower end of the user's face F is within the view angle θ3, the attachment angle θ2 of the camera 6 can be determined to be an allowable value. Namely, it is sufficient if the attachment angle θ2 of the camera 6 is set to a value falling within the angle range that simultaneously satisfies the states of FIGS. 4 and 5, and it is preferable that the attachment angle θ2 of the camera 6 be set to an intermediate value within the angle range.

Thus, an optimal attachment angle θ2 for the camera 6 is determined in accordance with the range of the inclination angle θ1 of the display panel 10, the view angle θ3 of the camera 6, the height H1 from the installation surface 101 of the PC 100 to the camera 6, and the position, relative to the camera 6, of the user's face F who operates the PC 100. The height H1 from the installation surface 101 to the camera 6 will vary depending upon the size of the display panel 10, the height of the stand 20, and the inclination angle θ1 of the display panel 10. Further, as parameters for the position of the user's face F (which varies between individuals), the horizontal distance D between the user's eyes and the camera 6, and the height H2 from the installation surface 101 to the user's eyes, for example, can be used.

Regarding the above, an example will be described.

As aforementioned, the height H1 of the camera 6 varies depending upon the size of the display panel 10, the height of the stand 20, and the inclination angle θ1 of the display panel 10. For instance, the height H1 of the camera 6 assumed when a 21-inch display panel 10 was inclined by 15° was about 37 cm (including the height of the stand 20), while the height H1 of the camera 6 assumed when the 21-inch display panel 10 was inclined by 30° was about 34 cm (including the height of the stand 20). Similarly, the height H1 of the camera 6 assumed when a 23-inch display panel 10 was inclined by 15° was about 39 cm (including the height of the stand 20), while the height H1 of the camera 6 assumed when the 23-inch display panel 10 was inclined by 30° was about 35.5 cm (including the height of the stand 20).

In the embodiment, an optimal attachment angle θ2 for the camera 6, which simultaneously satisfies all the above-mentioned cases, was detected. In all the cases, the distance between the user's eyes and the camera 6 was set to 60 cm, and the user's eyes height H2 was set to 40 cm. At this time, the view angle θ3 of the camera 6 was 75°. Under these conditions, the optimal attachment angle θ2 of the camera 6 was detected to be 12°. Namely, in all cases where the display panels 10 of the above-mentioned two sizes were inclined by the inclination angle θ1 of 15° to 30°, the user's face F was photographed with the attachment angle θ2 of the camera 6 set to 12°, whereby it was confirmed that the face F fell within the view angle θ3 of the camera 6.

As described above, the optimal attachment angle θ2 of the camera 6 assumed when the camera 6 is fixed on the display panel 10 can be determined based on the size of the display panel 10, the inclination angle θ1, the height of the stand 20, the height H1 of the camera 6 determined from these factors, the view angle θ3 of the camera 6, the user's eyes height H2, and the distance D between the user's eyes and the camera 6. Accordingly, even if the camera 6 is fixed, the user's face F can be securely made to fall within the view angle θ3 of the camera 6 by appropriately setting the attachment angle θ2 of the camera 6.

Referring then to FIGS. 3 and 6 to 11, the camera attachment structure will be described in detail.

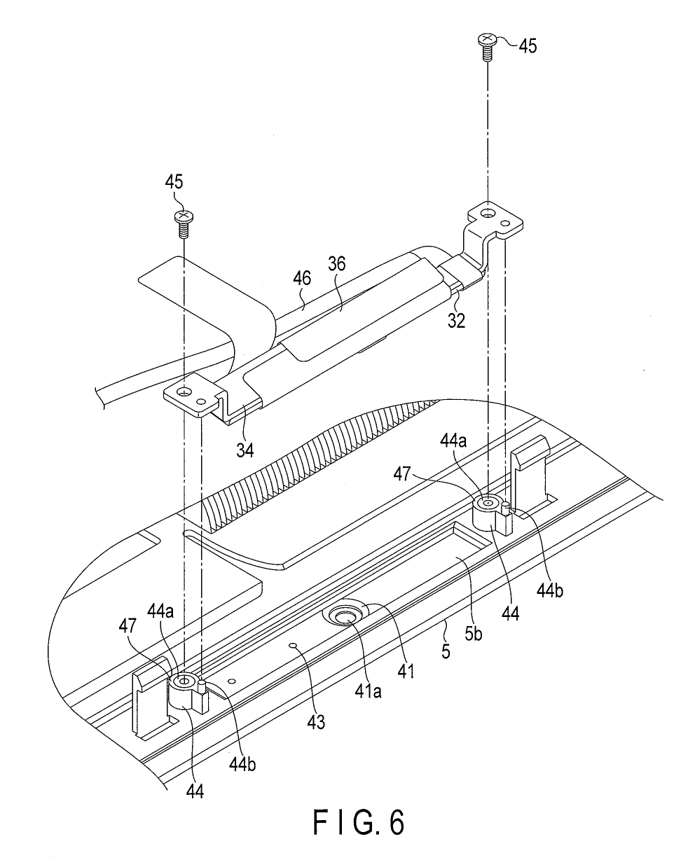

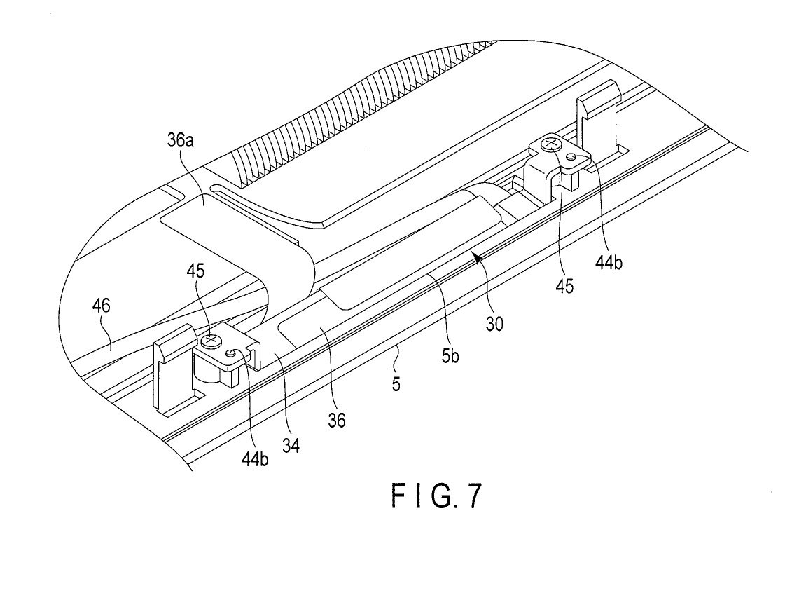

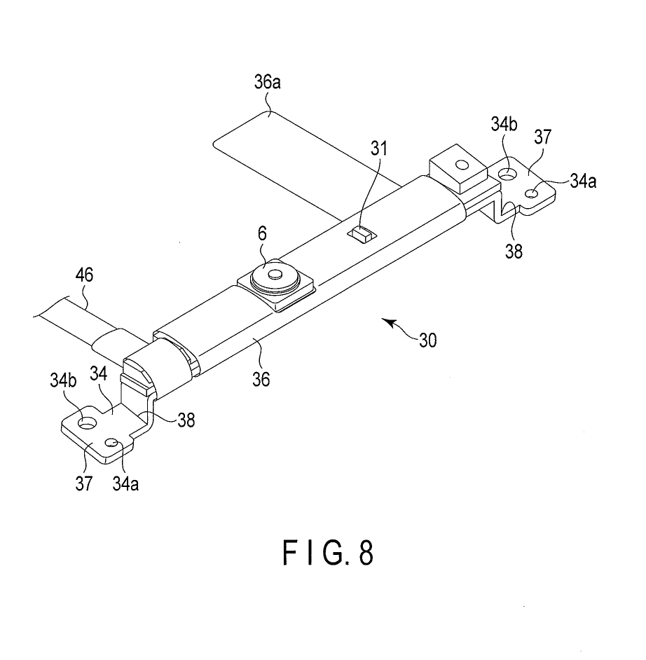

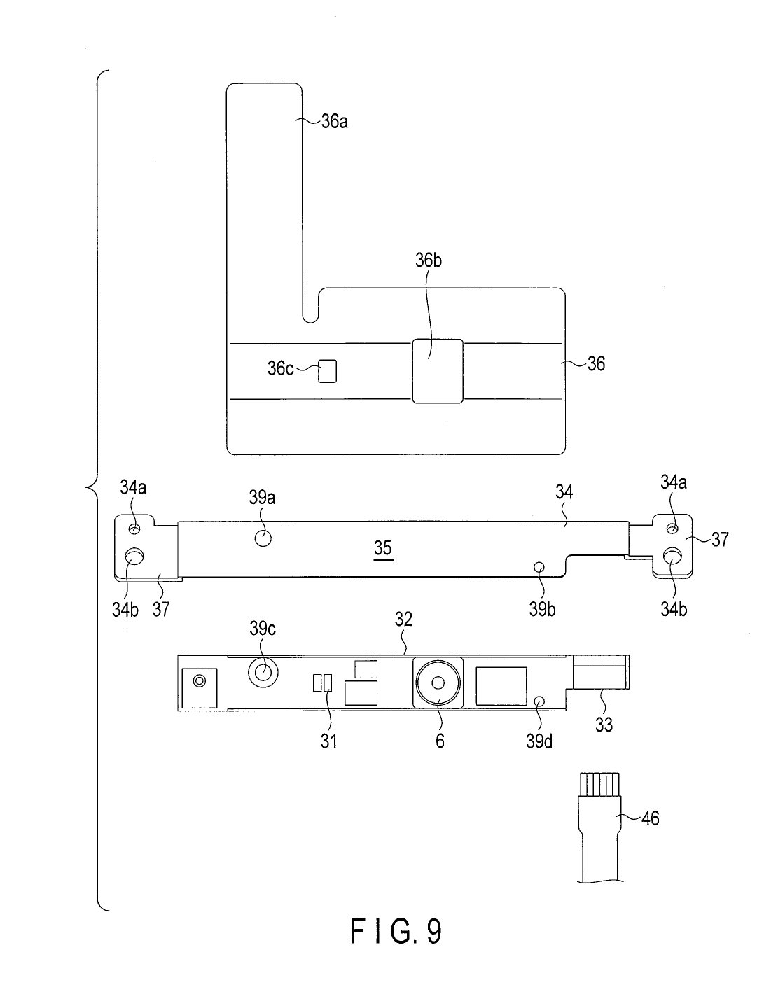

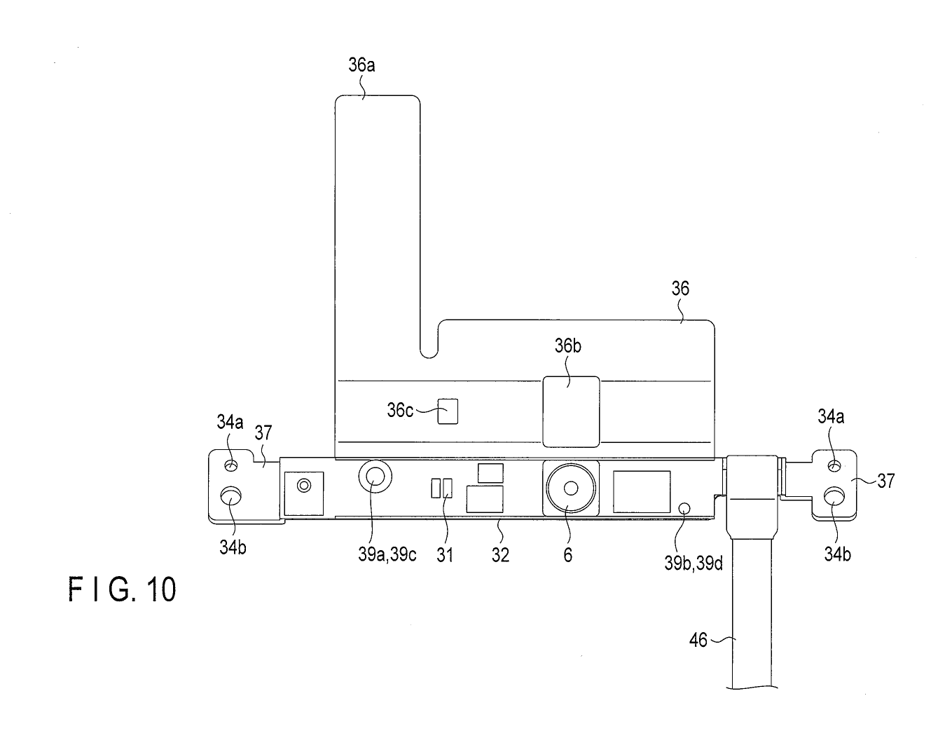

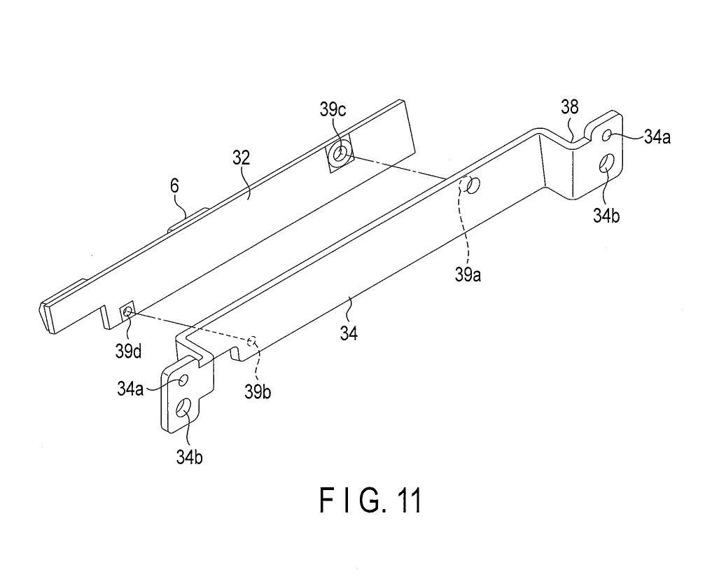

FIG. 6 is a partially enlarged perspective view illustrating the backside of the mask 5 on which the camera 6 is fixed. FIG. 7 is a partially enlarged perspective view illustrating a state in which a camera module 30 with the camera 6 is attached to the backside of the mask 5. FIG. 8 is a perspective view taken when the camera module 30 is seen from the front side of the mask. FIG. 9 is an exploded view of the camera module 30. FIG. 10 is a schematic view illustrating a state in which a static electricity sheet 36 incorporated in the camera module 30 is partially developed. FIG. 11 is a perspective view illustrating a module plate 32 and a steel plate 34 (holding member), incorporated in the camera module 30, viewed from behind.

As shown in FIG. 6, the backside of the mask 5 has a rectangular recess 5b for receiving the camera module 30. The recess 5b extends along the upper end of the mask 5. A circular receiving depression 41 for receiving the camera 6 is formed in the central portion of the bottom of the recess 5b, and a circular hole 41a is formed in the central portion of the receiving depression 41 through the front surface 5a of the mask 5. The hole 41a is coaxial with the optical axis L of the camera 6. As shown in FIG. 3, the hole 41a is filled with an optical film 42.

Further, a light-passing hole 43 is formed in the bottom of the recess 5b adjacent to the cameral receiving depression 41. The light-passing hole 43 is used to pass the light emitted from an emission diode 31 (LED 31) (see FIG. 8). The light-passing hole 43 reaches the front side 5a of the mask 5, and a film (not shown) is attached to the front side 5a. As shown in FIG. 9, the LED 31 is mounted on the elongated rectangular module plate 32 such that the LED and the camera 6 are arranged in line. As a result, the optical axis of the LED 31 is parallel with the optical axis L of the camera 6. The LED 31 functions as a lamp for informing the user that the camera 6 is activating.

Two bosses 44 for fixing the longitudinal opposite ends of the camera module 30 to the backside of the mask 5 are provided at positions outside the longitudinal opposite ends of the recess 5b. The bosses 44 have screw holes 44a for screwing screws 45 (see FIGS. 6 and 7) used to fasten the camera module 30. Further, the bosses 44 comprise pins 44b to be inserted into positioning holes 34a (see FIGS. 8 and 9) formed in the steel plate 34 described later. The pins 44b are provided just above the respective screw holes 44a along the vertical axis. The end faces 47 of the bosses 44 are on the same plane parallel with the display screen 10a as shown in FIG. 6.

The camera module 30 comprises a module plate 32 with the camera 6 and the LED 31 mounted thereon, a steel plate 34 attached to the backside of the module plate 32 by double-side tape, and an electrostatic sheet 36, as shown in FIG. 9. A connector 33 for connecting a cable 46 of signal lines and a power supply line to a longitudinal one end of the module plate 32.

The steel plate 34 has an attachment surface 35 to which the backside of the module plate 32 is attached, and fixing surfaces 37 to be brought into contact with end faces 47 of the bosses 44 provided on the backside of the mask, thereby fixing the bosses. The attachment surface 35 and the opposite fixing surfaces 37 are positioned at the same side of the steel plate 34. Namely, the steel plate 34 is formed by bending a slim metal plate. The fixing surfaces 37 provided at the opposite ends of the steel plate 34 have holes 34b formed adjacent to the above-mentioned positioning holes 34a for inserting screws 45 therethrough.

In particular, the steel plate 34 is angled twice between the attachment surface 35 and the opposite fixing surfaces 37 such that the two fixing surfaces 37 are slightly twisted with respect to the attachment surface 35. Namely, the steel plate 34 has obliquely inclined angled portions 38 (see FIGS. 3 and 8) at its opposite ends, at which angled portions 38, the metal plate is angled at the same angle as the attachment angle θ2 of the camera 6. By virtue of this structure, when the steel plate 34 is fastened to the bosses 44, the attachment surface 35 is positioned, twisted by the attachment angle θ2 with respect to the display screen 10a.

Namely, when the camera module 30 is attached to the backside of the mask 5 as shown in FIGS. 3 and 7, the attachment surface 35 with the camera module 30 attached thereto is twisted by the attachment angle θ2 with respect to the fixing surfaces 37 of the steel plate 34 attached to the end faces 47 of the bosses 44 positioned parallel to the display screen 10a, with the result that the optical axis L of the camera 6 is downwardly oriented by the attachment angle θ2 with respect to the perpendicular line P of the display screen 10a. At this time, the optical axis of the LED 31 mounted on the module plate 32 is also downwardly oriented by the attachment angle θ2 with respect to the display screen 10a.

When the camera module 30 of the above structure is assembled, two (small and large) projections 39a and 39b projecting from the attachment surface 35 of the steel plate 34 are fitted into two (small and large) holes 39c and 39d formed in the module plate 32, thereby adhering the backside of the module plate 32 to the attachment surface 35 of the steel plate 34 by means of double-sided tape. After that, one end of the backside of the electrostatic sheet 36 is attached to the backside of the attachment surface 35 of the steel plate 34 as shown in FIG. 10, thereby covering the overlapped steel plate 34 and module plate 32 with the electrostatic sheet 36. At this time, the camera 6 incorporated in the camera module 30 is exposed through a relatively large rectangular window 36b in the electrostatic sheet 36, and the LED 31 is exposed through a relatively small rectangular window 36c in the electrostatic sheet 36. Lastly, the cable 46 is connected to the connector 33 provided at one end of the module plate 32. The resultant camera module assembly is shown in FIG. 8.

When the thus-assembled camera module 30 is attached to the mask 5, the camera 6 is opposed to the receiving depression 41 of the recess 5b formed in the backside of the mask 5, and the LED 31 is opposed to the light-passing hole 43. In this state, the camera module 30 is fitted into the recess 5b. The camera module 30 can be easily positioned by inserting the pins 44b of the bosses 44 into the positioning holes 34a formed in the opposite ends of the steel plate 34. Where the camera module 30 is thus positioned, the holes 34b formed in the opposite ends of the steel plate 34 are alighted with the screw holes 44a of the bosses 44. In this state, the screws 45 are inserted through the holes 34b of the steel plate 34 and screwed into the screw holes 44a of the bosses 44, whereby the camera module 30 is fastened to the mask 5.

When the camera module 30 is thus attached to the mask 5, the fixing surfaces 37 of the steel plate 34 are positioned parallel to the display screen 10a of the PC 100, since they are in contact with the end faces 47 of the bosses 44 projecting from the backside of the mask 5, and the end faces 47 are parallel with the display screen 10a. In contrast, the optical axes of the camera 6 and the LED 31, which are mounted on the module plate 32 attached to the backside of the attachment surface 35 of the steel plate 34 twisted by the attachment angle θ2 with respect to the fixing surfaces 37, are downwardly oriented by the attachment angle θ2 with respect to the perpendicular line P of the display screen 10a.

As well as the above-mentioned attachment structure of the embodiment, the following two structures, for example, are possible to enable the optical axis L of the camera 6 to incline with respect to the perpendicular line P of the display screen 10a.

Firstly, a structure in which the bosses 44 projecting from the backside of the mask 5 are inclined is possible. However, in this structure, it is difficult to form such inclined bosses integral as one body. Further, it is necessary to also incline the screw holes 44a in accordance with the inclined bosses 44. It is difficult to process such inclined screw holed 44a, and the attachment of the camera module 30 is also difficult. Thus, greater time and labor are required.

Secondly, only the end faces 47 of the bosses 44 may be inclined. However, if the end faces 47 are inclined, when the screws 45 are screwed into the screw holes 44a, undesirable gaps will occur between the end faces 47 and the camera module 30. These gaps will degrade the attachment stability of the camera module 30.

In contrast, if the method of processing the steel plate 34 for fixing the camera module 30 is employed as in the embodiment, increase in work burden associated with the attachment of the camera module 30 can be avoided at least, and degradation of the attachment stability of the camera module 30 can also be avoided. In addition, the steel plate 34 can be relatively easily processed, and hence the method of the embodiment will not involve a significant increase in manufacturing cost.

As described above, since in the embodiment, the camera 6 is fixed to the display panel 10, the user does not have to care about the angle of the camera 6 when operating the PC 100. Thus, the PC 100 of the embodiment is much convenient to the user. Further, since the camera 6 is fixed, no mechanism for rotating the camera 6 is required, which results in simplification of the entire structure and in cost reduction.

Furthermore, since in the embodiment, the LED 31 is mounted on the module plate 32 with the camera 6 mounted thereon, the optical axis of the LED 31 can be inclined at the same angle as that of the camera 6. As a result, the LED 31 having a relatively strong directivity can be oriented toward the user's face, thereby enabling the user to easily determine whether the camera 6 is operating.

In the above-described television receiver and electronic device according to the embodiment, since the camera 6 having its attachment angle θ2 optimized is fixed to the display panel 10, the user does not have to adjust the angle of the camera 6. Further, in the embodiment, since no mechanism for rotating the camera 6 is required, the entire structure can be simplified and the manufacturing cost can be reduced.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A television receiver comprising:
a display panel with a display screen;
a support section supporting the display panel and configured to hold the display screen so that a line perpendicular to the display screen is directed upward at an angle inclined with respect to a horizontal line; and
a camera attached to the display panel above the display screen, oriented downward with respect to the line perpendicular to the display screen.

2. The television receiver of claim 1, wherein an attached angle of the camera is set to a value falling within an angular range in which the display panel is permitted to incline by the support section, and in which the display screen is viewed within a vertical view angle of the camera.

3. The television receiver of claim 1, wherein the camera is attached to the display panel by a holding member with a same angle as an attachment angle of the camera relative to the display panel.

4. The television receiver of claim 3, wherein the holding member includes an attachment surface on which the camera is attached, the attachment surface being inclined by the attachment angle relative to the display screen.

5. The television receiver of claim 4, wherein the attachment surface is in contact with a backside of a plate on which the camera and a lamp configured to indicate whether the camera is operating are mounted.

6. The television receiver of claim 5, wherein the lamp is a light emission diode mounted on the plate, and an optical axis of the lamp is parallel with an optical axis of the camera.

7. An electronic device comprising:
a main unit with a screen;
a support section supporting the main unit such that the main unit inclines with the screen oriented upward; and
a camera attached above the screen, oriented downward with respect to a line perpendicular to the screen.

8. The electronic device of claim 7, wherein a attached angle of the camera is set to a value falling within an angular range in which the main unit is permitted to incline by the support section, and in which the screen is viewed within a vertical view angle of the camera.

9. The electronic device of claim 7, wherein the camera is attached to the main unit by a holding member with a same angle as an attachment angle of the camera relative to the main unit.

10. The electronic device of claim 9, wherein the holding member includes an attachment surface on which the camera is attached, the attachment surface being inclined by the attachment angle relative to the screen.

11. The electronic device of claim 10, wherein the attachment surface is in contact with a backside of a plate on which the camera and a lamp configured to indicate whether the camera is operating are mounted.

12. The electronic device of claim 11, wherein the lamp is a light emission diode mounted on the plate, and an optical axis of the lamp is parallel with an optical axis of the camera.
